(19) United States
(12) Patent Application Publication
(10) Pub. No.: US 2013/0219897 A1
(43) Pub. Date: Aug. 29, 2013

(54) COMBUSTOR AND GAS TURBINE

(71) Applicants: Sosuke Nakamura, Tokyo (JP); Yoshikazu Matsumura, Tokyo (JP); Hikaru Katano, Tokyo (JP)

(72) Inventors: Sosuke Nakamura, Tokyo (JP); Yoshikazu Matsumura, Tokyo (JP); Hikaru Katano, Tokyo (JP)

(73) Assignee: MITSUBISHI HEAVY INDUSTRIES, LTD., Tokyo (JP)

(21) Appl. No.: 13/407,283

(22) Filed: Feb. 28, 2012

(51) Int. Cl. F23R 3/28; F23R 3/42; F02C 3/04

(52) U.S. Cl. 60/737; 60/805

(57) ABSTRACT

The combustor of the present invention is provided with a combustor basket to which air A is supplied from outside, first nozzles which are installed in a plural number annularly along an inner circumference of the combustor basket to individually supply premixed gas M of the air (A) with a fuel (f) into the combustor basket, and a transition piece, a base end of which is connected to the combustor basket, and which burns the premixed gas (M) supplied from the first nozzles to form a flame front (F) which spreads to an outer circumference toward the leading end in an axial direction. Each of the first nozzles supplies the premixed gas (M) by changing the fuel concentration around the center axis of the first nozzle so that the flame front (F) is made uniform in temperature in the axial direction.

### TECHNICAL FIELD

The present invention relates to a combustor and a gas turbine.

### BACKGROUND ART

In the field of gas turbines, there is conventionally available a gas turbine which uses a premixed combustion-type combustor, as a combustor which blows a fuel into compressed air to effect combustion. As this premixed combustion-type combustor, there is one which is provided with a combustor basket to which compressed air is supplied from a compressor, a plurality of main nozzles which is arrayed annularly along an inner circumference of the combustor basket, and a pilot nozzle which is arrayed on a center axis of the combustor basket to assist combustion of a pilot flame. The combustor of this type supplies premixed gas which is a fuel mixed with compressed air through the main nozzles into the combustor basket to ignite the premixed gas with the pilot flame, thereby conducting a premixed combustion.

For example, in Patent Document 1 given below, a premixed combustion burner is constituted with a fuel nozzle, a burner tube which surrounds the fuel nozzle to form an air channel between the fuel nozzle and itself, and swirlers which are arranged at a plurality of sites on an outer circumference surface of the fuel nozzle in a circumferential direction to swirl the air in circulation. In this combustor, a notch is formed at a rear edge on an inner circumference side of the swirler to cause a vortex air flow on the downstream side of the swirler. Thereby, premixed gas is made uniform in fuel concentration in a radial direction of the air channel, thus suppressing an increase in NOx and preventing backflow of flame (flashback).

### PRIOR ART DOCUMENT

### Patent Document

Patent Document 1: Japanese Published Unexamined Patent Application No. 2007-285572

### SUMMARY OF THE INVENTION

### Problems to be Solved by the Invention

Moreover, in the above-described combustor, usually, cooling air is caused to flow or is blown along inner circumference surfaces of a combustor basket and a transition piece, thereby cooling the combustor basket, the transition piece, and members around them. Further, the combustor is structured so that the cooling air flows through spaces formed between burner tubes of the plurality of main nozzles and a pilot cone arranged outside a pilot nozzle.

However, in a conventional combustor, even if premixed gas at an end of an outlet of the burner tube is made uniform in fuel concentration in a radial direction, the cooling air will be included before the premixed gas reaches a flame front. Therefore, the fuel concentration is not made uniform at the flame front and there is the possibility that a portion of the fuel concentration is locally increased. Here, thermal NOx which depends on a flame temperature on combustion is increased exponentially with an increase in flame temperature. Therefore, when such a site occurs that a flame temperature is locally raised due to a local increase in fuel concentration, there is posed a problem of increased NOx.

The present invention has been made in view of the above situation, an object of which is to suppress the occurrence of NOx from a combustor and a gas turbine.

### Means for Solving the Problem

The combustor of the present invention is provided with a combustor basket, to which air is supplied from outside, first nozzles which extend in an axial direction of the combustor basket and are installed in a plural number, with an interval kept, along an inner circumference of the combustor basket, thereby individually supplying premixed gas of the air with a fuel into the combustor basket, and a transition piece, a base end of which is connected to the combustor basket, and which burns the premixed gas supplied from the first nozzle to form a flame front. Each of the first nozzles supplies the premixed gas by changing the fuel concentration around the center axis of the first nozzle so that the flame front is made uniform in temperature in the axial direction.

According to the above-described constitution, each of the first nozzles supplies the premixed gas by changing the fuel concentration around the center axis thereof so that the flame front is made uniform in temperature in the axial direction. Therefore, even if cooling air is included in the premixed gas, it is possible to reduce the variance in fuel concentration of the premixed gas across the axial direction. Thereby, the flame front is formed by the premixed gas uniform in fuel concentration across the axial direction, thus making it possible to suppress combustion of the flame front at an uneven temperature in the axial direction and also suppress the occurrence of NOx.

Further, the first nozzle may be configured so that a second range which is inside in the radial direction of the combustor basket is made relatively higher in fuel concentration of the premixed gas at a leading-end outlet of the first nozzle than a first range which is outside in the radial direction of the combustor basket.

According to the above-described constitution, where the fuel concentration of the premixed gas supplied from the first nozzle is influenced by cooling air flowing between the first nozzle and a second nozzle installed inside the first nozzle, the second range inside in the radial direction of the combustor basket is made relatively higher in fuel concentration of the premixed gas at the leading-end outlet of the first nozzle than the first range outside in the radial direction of the combustor basket. Therefore, the first range at which the fuel concentration is relatively less likely to decrease is decreased in fuel concentration, while the second range at which the fuel concentration is relatively likely to decrease is increased in fuel concentration. Thereby, the premixed gas which reaches a flame front can be made uniform in fuel concentration in the axial direction by a relatively simple constitution.

Still further, the first nozzle may be configured so that the second range which is outside in the radial direction of the combustor basket is made relatively higher in fuel concentration of the premixed gas at the leading-end outlet of the first nozzle than the second range which is inside in the radial direction of the combustor basket.

According to the above-described constitution, where the fuel concentration of the premixed gas supplied from the first nozzle is influenced by cooling air flowing on the inner circumference surfaces of the combustor basket and the transition piece, the second range which is outside in the radial direction of the combustor basket is made relatively higher in fuel concentration of the premixed gas at the leading-end outlet of the first nozzle than the second range which is inside in the radial direction of the combustor basket. Therefore, the second range at which the fuel concentration is relatively less likely to decrease is decreased in fuel concentration, while the second range at which the fuel concentration is relatively likely to decrease is increased in fuel concentration. Thereby, the premixed gas which reaches the flame front can be made uniform in fuel concentration in the axial direction using a relatively simple constitution.

In addition, the first nozzle may be provided with a nozzle main body which is installed on the center axis of the first nozzle, swirlers which are installed in a plural number on an outer circumference of the nozzle main body to form a swirl flow of the premixed gas, and a plurality of fuel ejection parts which is formed on each of the swirlers to eject the fuel, and wherein the plurality of fuel ejection parts may eject the fuel by changing an amount of the ejected fuel around the center axis of the first nozzle.

According to the above-described constitution, the plurality of fuel ejection parts ejects the fuel by changing an amount of the ejected fuel around the center axis of the first nozzle. Therefore, the premixed gas around the center axis of the first nozzle can be easily changed in fuel concentration.

Further, the swirler may be provided with the fuel ejection part at a plurality of sites in the radial direction of the nozzle main body, and wherein the plurality of fuel ejection parts may eject the fuel by changing the amount of the ejected fuel in the radial direction of the nozzle main body.

According to the above-described constitution, the plurality of fuel ejection parts ejects the fuel by changing the amount of the ejected fuel in the radial direction of the nozzle main body. Therefore, the premixed gas can be adjusted for the fuel concentration in the radial direction.

Further, each of the plurality of fuel ejection parts may be provided with a fuel ejection port to change the amount of the ejected fuel by making an opening area of the fuel ejection port different.

Still further, each of the plurality of fuel ejection parts may be provided with a fuel ejection port to change the amount of the ejected fuel by making the number of the fuel ejection ports different.

According to the above-described constitution, the fuel ejection port is different in number. Therefore, the amount of the ejected fuel can be changed to change the fuel concentration of the premixed gas by a relatively simple constitution.

In addition, the gas turbine of the present invention may be provided with a compressor, a combustor, and a turbine, and wherein the combustor is that which is provided with any one of the above-described combustors.

According to the above-described constitution, since the combustor is provided with any one of the above-described combustors, it is possible to constitute a gas turbine in which the occurrence of NOx is suppressed.

### Advantageous Effect of the Invention

According to the combustor of the present invention, it is possible to suppress the occurrence of NOx.

According to the gas turbine of the present invention, it is possible to constitute a gas turbine in which the occurrence of NOx is suppressed.

### BRIEF DESCRIPTION OF THE DRAWINGS

FIG. 1 is a schematic sectional view which shows an entire constitution of a gas turbine 1 related to a first embodiment of the present invention.

FIG. 2 is an enlarged sectional view which shows a combustor 10 related to the first embodiment of the present invention.

FIG. 3 is an enlarged sectional view which shows major parts of the combustor 10 related to the first embodiment of the present invention.

FIG. 4 is an enlarged view which shows the major parts related to the first embodiment of the present invention and a sectional view taken along arrow 1 in FIG. 3.

FIG. 5 is a graph which shows a temperature converted on the basis of fuel concentration of premixed gas M on a cross section in FIG. 3 related to the first embodiment of the present invention and a flame temperature on a flame front F of the premixed gas M corresponding to the cross section in FIG. 3. In the graph, a position in the radial direction from the nozzle center axis P3 is taken as a longitudinal axis, while a temperature converted on the basis of the fuel concentration (temperature conversion concentration) is taken as a horizontal axis.

FIG. 6 is a graph which shows a comparative example of the combustor 10 related to the first embodiment of the present invention and corresponds to FIG. 5 which shows regarding the combustor 10.

FIG. 7 is a graph which shows a temperature converted on the basis of fuel concentration of the premixed gas M on the cross section in FIG. 3 related to a second embodiment of the present invention and a flame temperature on the flame front F of the premixed gas M corresponding to the cross section in FIG. 3. In the graph, a position in the radial direction from the nozzle center axis P3 is taken as a longitudinal axis, while a temperature converted on the basis of the fuel concentration (temperature conversion concentration) is taken as a horizontal axis.

FIG. 8 is a graph which shows a comparative example of the combustor 10 related to the second embodiment of the present invention and corresponds to FIG. 7 which shows regarding the combustor 10.

### MODE FOR CARRYING OUT THE INVENTION

### First Embodiment

A description will be given of the first embodiment of the present invention with reference to the drawings.

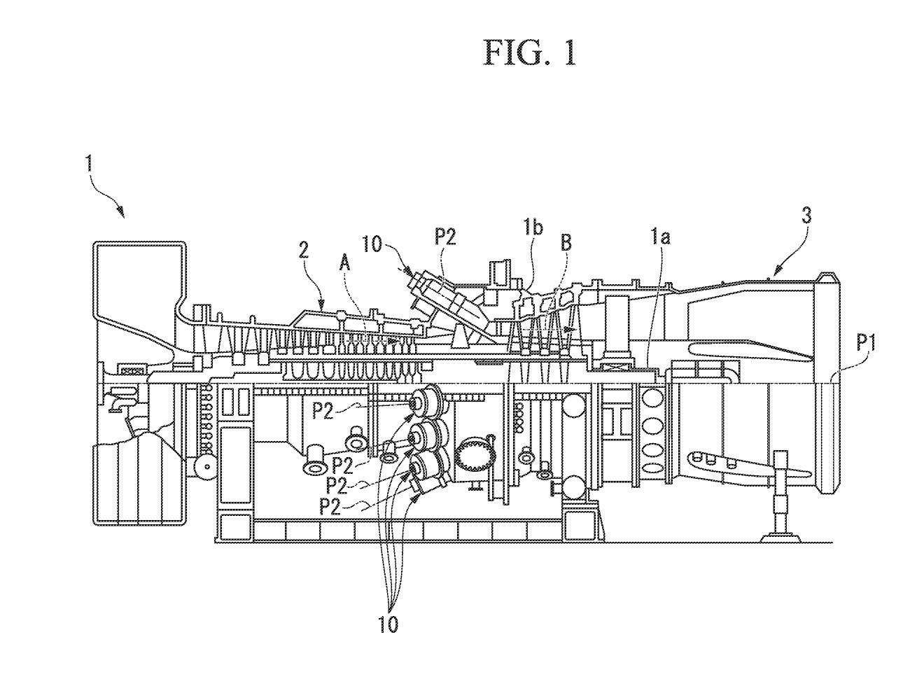

FIG. 1 is a schematic sectional view which shows an entire constitution of the gas turbine 1 related to the embodiment of the present invention.

As shown in FIG. 1, the gas turbine 1 is substantially constituted with a compressor 2, a plurality of combustors 10, and a turbine 3.

The compressor 2 incorporates air as a working fluid to generate compressed air (air) A.

As shown in FIG. 1, the plurality of combustors 10 is communicatively connected to an outlet of the compressor 2 and mixes a fuel with compressed air A supplied from the compressor 2 and also burns the fuel, thereby producing a combustion gas B high in temperature and pressure.

The turbine 3 converts thermal energy of the combustion gas B sent from the combustors 10 to rotational energy of a rotor 1a. Then, the rotational energy is transmitted to a generator (not illustrated) coupled to the rotor 1a.

Each of the combustors 10 is arrayed in a radial manner in a state that each combustor center axis P2 is inclined to the side in which an inlet of the combustor 10 is spaced away to a greater extent in the radial direction than an outlet thereof with respect to the rotational center axis P1 of the rotor 1a in the gas turbine 1.

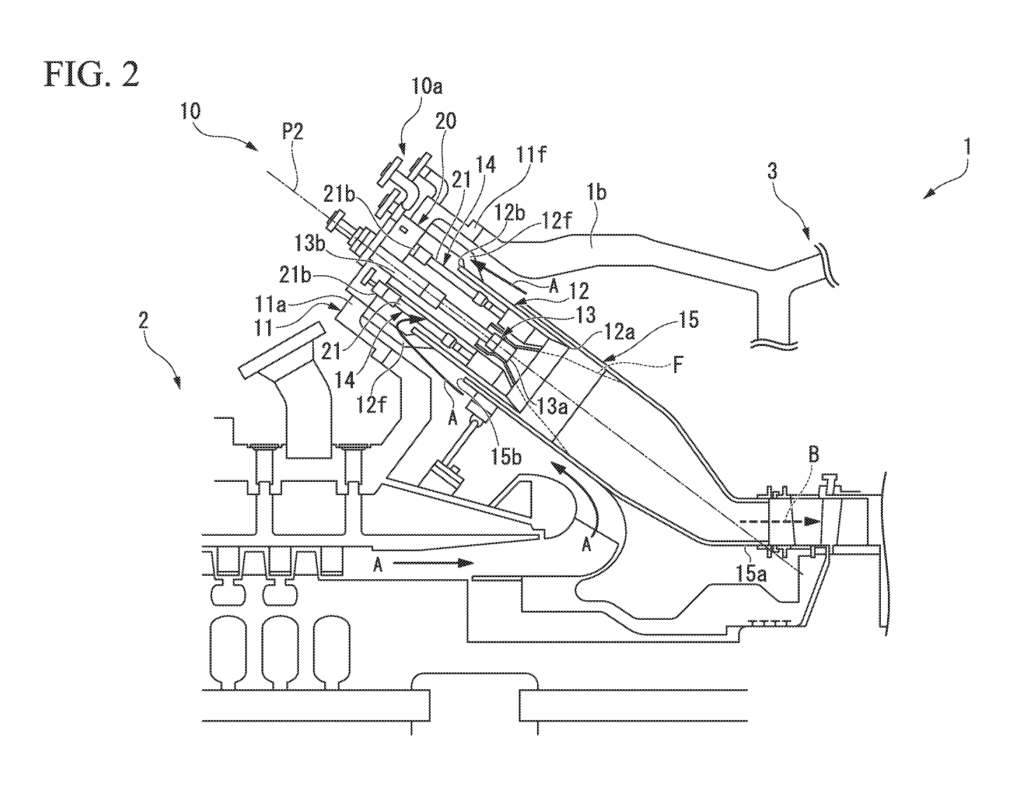

FIG. 2 is an enlarged sectional view which shows the combustor 10.

As shown in FIG. 2, each of the combustors 10 is provided with an external cylinder 11, a combustor basket 12, a main nozzle (first nozzle) 14, a pilot nozzle (second nozzle) 13 and a transition piece 15.

The external cylinder 11 is that in which the center axis thereof overlaps with the combustor center axis P2 and a flange 11f extending from an outer circumference of the external cylinder 11 at one end in the axial direction thereof to outside in the radial direction thereof is fixed to a casing 1b. A fuel supply part 10a which supplies a fuel to the main nozzle 14 and a nozzle pipe base 20 which supports the main nozzle 14 are arrayed at a base end part 11a side at the other end in the axial direction of the external cylinder 11.

The combustor basket 12 is formed so as to be smaller in diameter than the external cylinder 11, and the center axis of the combustor basket 12 overlaps with the combustor center axis P2. The combustor basket 12 is fixed to the external cylinder 11 via a supporting part 12f or the like extending from a base-end opening part 12b side.

As shown in FIG. 2, the combustor basket 12 is that in which a clearance with the external cylinder 11 is given as a flow channel of compressed air A and the compressed air A is introduced inside from the base-end opening part 12b at the base end part 11a side of the external cylinder 11.

The pilot nozzle 13 is formed in a long continuous shape and arrayed on the combustor center axis P2. The pilot nozzle 13 is supported at the base end 13b side by a nozzle pipe base 20, etc., and surrounded at the leading end 13a side by the combustor basket 12. The above-described pilot nozzle 13 forms a pilot flame at the leading end 13a side by a fuel supplied from the fuel supply part 10a to the base end 13b side.

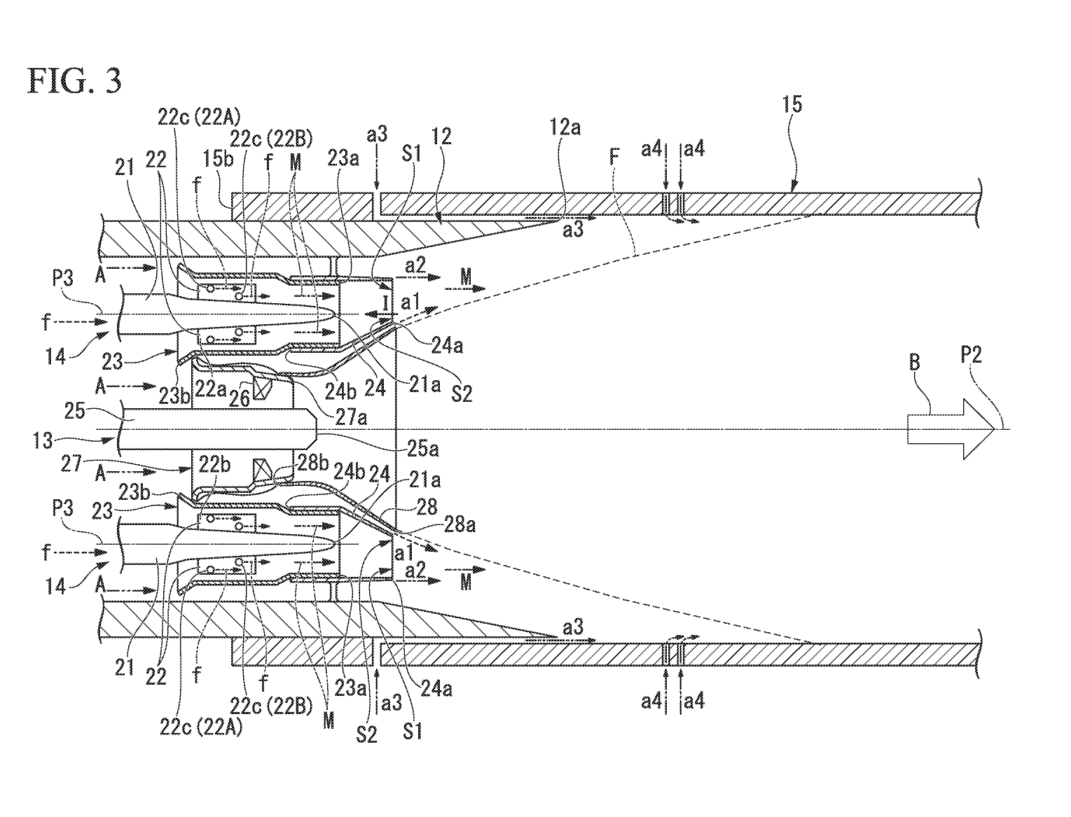

The main nozzles 14 are arrayed in a plural number (for example, eight nozzles) annularly at an equal pitch along an inner circumference of the combustor basket 12. The plurality of main nozzles 14 is arrayed in such a manner that each of the nozzle center axis P3 (refer to FIG. 3) is parallel with the combustor center axis P2 of the combustor 10.

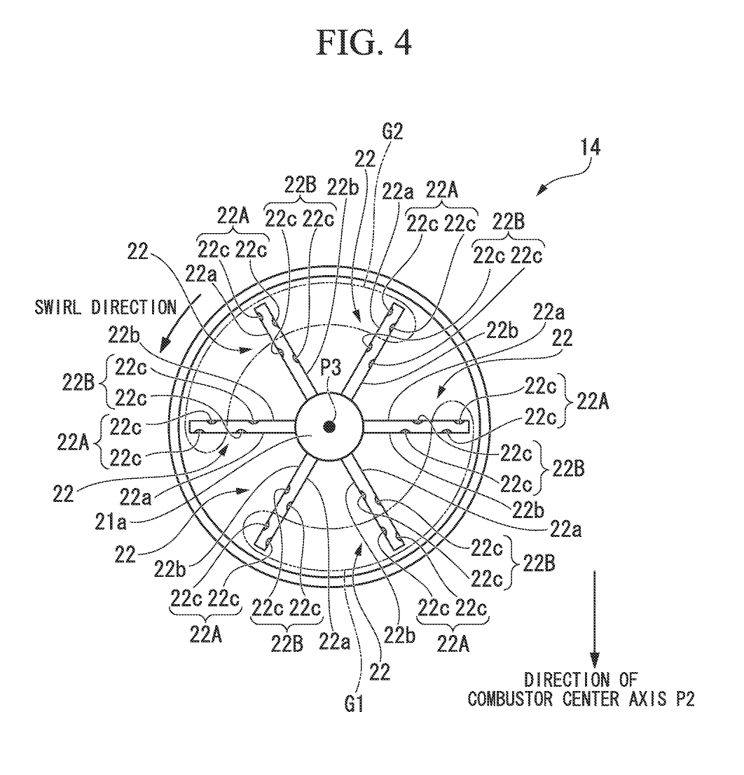

FIG. 3 is an enlarged sectional view which shows the major parts of the combustor 10, and FIG. 4 is a sectional view taken along arrow 1 in FIG. 3.

As shown in FIG. 3, each of the main nozzles 14 is provided with a main nozzle main body 21, a plurality of main swirlers 22, a main nozzle tube 23 and an extension pipe 24. Further, the pilot nozzle 13 is provided with a pilot nozzle main body 25, a plurality of pilot swirlers 26, a pilot nozzle tube 27 and a pilot cone 28.

As shown in FIG. 2, the main nozzle main body 21 is formed in a long continuous shape and positioned on the nozzle center axis P3. As shown in FIG. 2, the main nozzle main body 21 is that in which a base end 21b side thereof is supported by the nozzle pipe base 20 and a fuel flow channel connected to the fuel supply part 10a is formed internally.

As shown in FIG. 3 and FIG. 4, the main swirlers 22 are arrayed in a radial manner on an outer circumference of the main nozzle main body 21 at the leading end 21a side in a plural number (six in the present embodiment), thereby forming a swirl flow of the premixed gas M.

As shown in FIG. 4, a fuel ejection part 22A and a fuel ejection part 22B are arrayed on each of the main swirlers 22.

The fuel ejection parts 22A, 22B are individually constituted with a pair of fuel ejection ports 22c formed on a pressure side 22a and a suction side 22b on the main swirler 22. The fuel ejection part 22A is formed outside in the radial direction, and the fuel ejection part 22B is formed inside in the radial direction.

Each of the fuel ejection ports 22c is communicatively connected to a fuel flow channel of the main nozzle main body 21. The fuel ejection port 22c is formed in such a manner that for each of the fuel ejection parts 22A and 22B, the fuel ejection port 22c formed on the pressure side 22a is to be positioned outside in the radial direction and the fuel ejection port 22c formed on the suction side 22b is to be positioned inside in the radial direction.

As shown in FIG. 3, because of the above-described constitution, the fuel ejection parts 22A, 22B eject a fuel f from the fuel ejection ports 22c to produce the premixed gas M of the compressed air A with the fuel f.

The main nozzle tube 23 is arranged so that the center axis thereof overlaps with the nozzle center axis P3, with a tube leading-end opening 23a and a tube base-end opening 23b both pointed at the axial direction. Then, the main nozzle tube 23 surrounds the leading end 21a of each of the main nozzle main bodies 21 and a plurality of main swirlers 22.

The extension pipe 24 is that in which a pipe base-end opening 24b side in the axial direction is connected to a tube leading-end opening 23a side of the main nozzle tube 23. The extension pipe 24 is gradually decreased in cross section of the flow channel from the pipe base-end opening 24b side to the pipe leading-end opening 24a side at the leading-end opening (leading-end outlet) 24a.

The extension pipe 24 causes cooling air a2 for a cooling film to flow out from an outer circumference wall side thereof in the radial direction of the pipe leading-end opening 24a.

As with the pilot nozzle 13, the above-described main nozzle 14 is surrounded by the combustor basket 12 at the leading end side at which the main nozzle tube 23, the extension pipe 24 and others are positioned.

The pilot nozzle 13 is provided at the leading end 25a side of the pilot nozzle main body 25 with a pilot nozzle tube 27, and an annular space is formed between the pilot nozzle tube 27 and the pilot nozzle main body 25. Then, a pilot swirler 26 is arrayed between the cylindrical pilot nozzle tube 27 and the pilot nozzle main body 25, and the pilot swirler 26 forms a swirl flow of the compressed air A.

The pilot cone 28 is that in which a base-end opening 28b is connected to a tube leading-end opening 27a side of the pilot nozzle tube 27. The pilot cone 28 is gradually increased in area of the flow channel from the base-end opening 28b to the leading-end opening 28a.

Further, a flow channel of the cooling air a1 is formed at a clearance between the extension pipe 24 and the pilot cone 28. The extension pipe 24 and the pilot cone 28 are cooled by the cooling air a1 which flows out from the flow channel.

As shown in FIG. 2 and FIG. 3, the transition piece 15 is that in which a base-end opening 15b is connected to the leading-end opening part 12a side of the combustor basket 12 and also a leading-end opening (the leading end in the axial direction) 15a is communicatively connected to the turbine 3. The transition piece 15 burns the premixed gas M which has been supplied from the main nozzle 14 and forms a flame front F which spreads outside in the radial direction to the leading-end opening 15a side.

As shown in FIG. 3, a flow channel of cooling air a3 is formed at a clearance between the transition piece 15 and the combustor basket 12. The cooling air a3 which has flown in from the flow channel flows along the inner circumference surface of the transition piece 15, thereby forming a cooling film. Further, as shown in FIG. 3, cooling air a4 flows in also from the downstream side of the leading-end opening part 12a of the combustor basket 12.

In the present embodiment, a description will be given of a case where, of the cooling air a1 to a4, the cooling air a1 flowing out from the clearance between the extension pipe 24 and the pilot cone 28 will be dominant in influence.

As described above, the main nozzle 14 supplies into the combustor basket 12 the premixed gas M which is a mixture of the compressed air A with the fuel f. In this instance, the main nozzle 14 supplies the premixed gas M by changing the fuel concentration around the nozzle center axis P3 of the main nozzle 14 so that the flame front F is made uniform in temperature in the axial direction.

In the main nozzle 14, the second range S2 which is inside in the radial direction of the combustor basket 12 is made relatively higher in fuel concentration at the pipe leading-end opening 24a than the first range S1 which is outside in the radial direction of the combustor basket 12 (the side which is spaced away from the combustor center axis P2).

As shown in FIG. 4, a specific constitution thereof is that in which, of six fuel ejection parts 22A, a group G1 in which the ejected fuel f reaches the first range S1 ejects a relatively small amount of fuel, while a group G2 in which the ejected fuel f reaches the second range S2 ejects a relatively large amount of fuel.

More specifically, as shown in FIG. 4, fuel ejection ports 22c are different in opening area between two fuel ejection parts 22A positioned inside in the radial direction of the combustor basket 12 and one fuel ejection part 22A adjacent to these two fuel ejection parts 22A in a swirl direction (the group G1), and remaining three fuel ejection parts 22A (the group G2).

It is noted that each of the fuel ejection ports 22c is equal in dimension in six fuel ejection parts 22B.

The opening area of the fuel ejection port 22c is set in such a manner that when a port diameter of each of the fuel ejection ports 22c belonging to the fuel ejection part 22B is set as 1, a port diameter of each of the fuel ejection ports 22c belonging to the group G1 is set as 0.9 and a port diameter of each of the fuel ejection ports 22c belonging to the group G2 is set as 1.1.

The fuel ejection port 22c is set for the position, number, and dimension of the port diameter, depending on the concentration distribution at the pipe leading-end opening 24a.

As described above, the six fuel ejection parts 22A are divided into two groups on the basis of an amount of the ejected fuel around the nozzle center axis P3 of the main nozzle 14. Further, on the same main swirler 22, the fuel ejection part 22A which is outside in the radial direction of the main nozzle main body 21 ejects a different amount of fuel from the fuel ejection part 22B which is inside thereof.

According to the above-described constitution, when a pressure is caused to act on the fuel f on the fuel flow channel of the main nozzle main body 21, the fuel f is ejected into the compressed air A in an amount depending on the opening area from each of the fuel ejection ports 22c.

Next, a description will be given of actions of the above-described combustor 10.

Upon starting operation of the gas turbine 1, the compressor 2 generates compressed air A. As shown in FIG. 2, the compressed air A will flow into the combustor basket 12 from the base-end opening part 12b of the combustor basket 12 of each of the combustors 10.

The compressed air A which has flown into the combustor basket 12 is partially used on combustion of a pilot flame by the pilot nozzle 13 and partially flows into the main nozzle tube 23 of the main nozzle 14.

Each of the fuel ejection ports 22c ejects the fuel f into the compressed air A which has flown into the main swirler 22 in an amount depending on the opening area. Then, the ejected fuel f is mixed with the compressed air A by the main swirler 22, producing premixed gas M and also forming a swirl flow of the premixed gas M.

When the premixed gas M has reached the pipe leading-end opening 24a of the extension pipe 24, the concentration thereof in the first range S1 is relatively low and the concentration thereof in the second range S2 is relatively high.

The premixed gas M which has flown out from the pipe leading-end opening 24a forms the flame front F, as shown in FIG. 3.

More specifically, the premixed gas M flows to the downstream side of the combustor 10 in a direction of the combustor center axis P2. The premixed gas M inside the combustor basket 12 (on the side of the combustor center axis P2) burns more inside in the radial direction in the upstream region. In other words, the premixed gas M outside in the radial direction of the combustor basket 12 reaches the downstream region further and also burns further outside in the radial direction.

That is, the premixed gas M which has flown out from the tube leading-end opening 23a burns earlier at the second range S2 which is inside the combustor basket 12 and higher in fuel concentration than at the first range S1.

On the other hand, when the premixed gas M flows to the downstream side, cooling air a1 is included at the second range S2 during which the premixed gas M flows to the downstream region. The premixed gas M which would be otherwise relatively high in fuel concentration at the pipe leading-end opening 24a becomes low and similar in fuel concentration to the first range S1.

As described above, a range where the premixed gas M burns is sequentially shifted from inside to outside in the radial direction of the combustor basket 12. A flame front F is formed by the premixed gas M which is substantially equal in fuel concentration in the axial direction. The thus formed flame front F is made uniform in flame temperature in the axial direction, producing NOx only slightly.

As described so far, according to the combustor 10, each of the main nozzles 14 supplies the premixed gas M by changing the fuel concentration around the nozzle center axis P3 thereof so that the flame front F is made uniform in temperature in the axial direction. It is, thus, possible to reduce a variance in fuel concentration of the premixed gas M in the axial direction. Thereby, even if the cooling air a1 is included across the premixed gas M, the flame front F is to be formed by the premixed gas M which is uniform in fuel concentration across the axial direction. As a result, it is possible to suppress combustion of the flame front F at an uneven temperature in the axial direction and also suppress the occurrence of NOx.

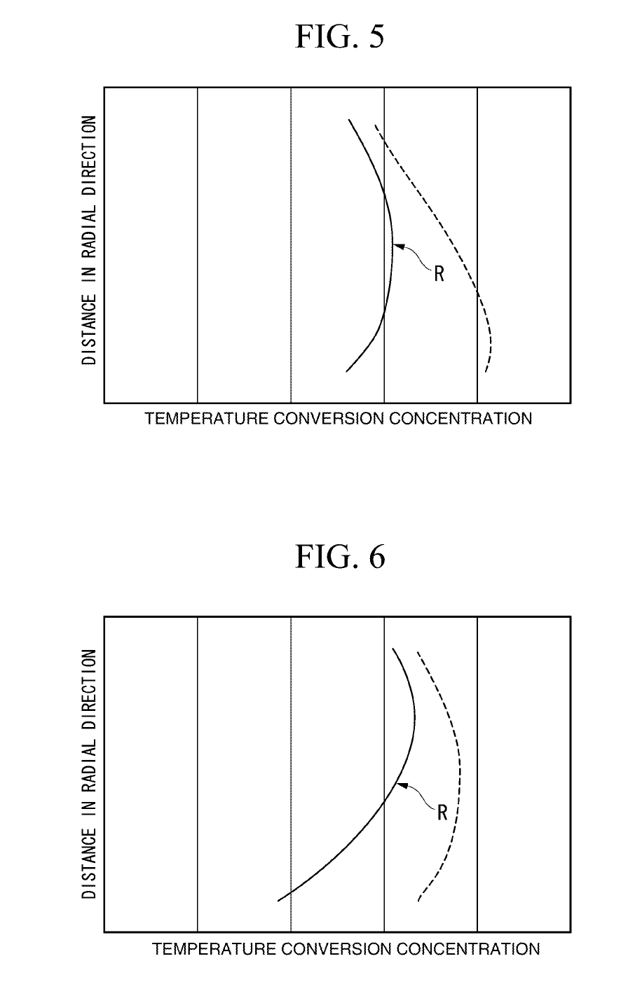

FIG. 5 is a graph which shows a temperature converted on the basis of fuel concentration of the premixed gas M at the pipe leading-end opening 24a of the main nozzle 14 and a flame temperature on the flame front F of the premixed gas M corresponding to the cross section in FIG. 3. In the graph, a position in the radial direction from the nozzle center axis P3 is taken as a longitudinal axis, while a temperature converted on the basis of the fuel concentration (temperature conversion concentration) is taken as a horizontal axis. In FIG. 5, the solid line indicates a flame temperature on the flame front F of the premixed gas M, the broken line indicates a value which is a temperature converted on the basis of the fuel concentration of the premixed gas M at the pipe leading-end opening 24a.

Further, FIG. 6 is a graph which shows a comparative example where the fuel ejection ports 22c are all made equal in opening area around each of the nozzle center axis P3 (the fuel ejection ports 22c of the fuel ejection part 22A are equal in port diameter to the fuel ejection ports 22c of the fuel ejection part 22B).

On the assumption that, as with the comparative example, the fuel ejection ports 22c are all made equal in opening area around each of the nozzle center axis P3 and the concentration distribution at the pipe leading-end opening 24a is made substantially uniform, the flame front F will have a temperature peak R (a maximum flame temperature) outside in the radial direction of the combustor basket 12, as shown by the solid line in FIG. 6, at which a flame temperature rises locally. On the other hand, the flame temperature decreases drastically along the inside in the radial direction from the temperature peak R.

This is due to the fact that the premixed gas M inside in the radial direction is likely to decrease in fuel concentration by the cooling air a1.

Meanwhile, in the combustor 10 of the present invention, unlike the comparative example, as shown in FIG. 5, the concentration distribution is not uniform at the pipe leading-end opening 24a but the concentration inside in the radial direction is made relatively higher than outside in the radial direction. Further, in the combustor 10 of the present invention, unlike the comparative example, a flame temperature M of the premixed gas on the flame front F is substantially uniform. Still further, in the combustor 10 of the present invention, as shown by the solid line in FIG. 5, the temperature peak R is lower than the comparative example. Since the combustion temperature is uniform in general to reduce a local rise in flame temperature in the combustor 10, it is possible to sufficiently suppress the occurrence of NOx.

Further, at the pipe leading-end opening 24a of the main nozzle 14, the second range S2 which is inside in the radial direction of the combustor basket 12 is made relatively higher in fuel concentration than the first range S1 which is outside in the radial direction of the combustor basket 12. Therefore, the first range S1 which is relatively less likely to decrease in fuel concentration and burns on the downstream side is decreased in fuel concentration, while the second range S2 which is relatively likely to decrease in fuel concentration and burns on the upstream side is increased in fuel concentration. Thereby, the premixed gas M which reaches the flame front F can be made uniform in fuel concentration in the axial direction using a relatively simple constitution.

Further, the fuel ejection parts 22A which are formed individually on the six main swirlers 22 are divided into two groups on the basis of an amount of the ejected fuel around the nozzle center axis P3. Therefore, the premixed gas M can be easily changed in fuel concentration around the nozzle center axis P3 so as to correspond to the second range S2 at which the premixed gas M burns easily at an earlier stage after the premixed gas M has flown out from the pipe leading-end opening 24a and the first range S1 at which it flows to the downstream region and burns at a later stage.

Further, on the same main swirler 22, the fuel ejection part 22A outside in the radial direction of the main nozzle 14 is made different in amount of the ejected fuel from the fuel ejection part 22B inside thereof. It is, thus, possible to adjust the fuel concentration of the premixed gas M in the radial direction easily and appropriately.

Still further, since the fuel ejection ports 22c are different in opening area, an amount of the ejected fuel can be changed to change the fuel concentration of the premixed gas M using a relatively simple constitution.

In addition, since the gas turbine 1 is provided with the combustor 10, it can be constituted so as to suppress the occurrence of NOx.

### Second Embodiment

In the first embodiment, a description has been given of a case where the cooling air a1 flowing out from a clearance between the extension pipe 24 and the pilot cone 28 becomes dominant in influence. However, in the second embodiment, a description will be given of a case where cooling air a2 for a cooling film from an outer circumference wall side of an extension pipe 24 in a radial direction of a pipe leading-end opening 24a, cooling air a3 flowing in from a flow channel at a clearance between a transition piece 15 and an combustor basket 12, and cooling air a4 flowing in from the downstream side of a leading-end opening part 12a of the combustor basket 12, that is, cooling air outside in the radial direction of the combustor basket becomes dominant in influence. Therefore, constitutions similar to those of the first embodiment will be omitted here.

In the present embodiment, in a main nozzle 14, a first range S1 which is outside in the radial direction of the combustor basket 12 is made relatively higher in fuel concentration at the pipe leading-end opening 24a than a second range S2 which is inside in the radial direction of the combustor basket 12 (the side coming closer to the combustor center axis P2).

In a specific constitution shown in FIG. 4, of six fuel ejection parts 22A, a group 1 in which an ejected fuel f reaches the first range S1 ejects a relatively large amount of fuel, while a group 2 in which the ejected fuel f reaches the second range S2 ejects a relatively small amount of fuel.

Fuel ejection ports 22c are set for the position, number, and dimension of the port diameter, depending on the concentration distribution at the pipe leading-end opening 24a.

Next, a description will be given of actions of the above-described combustor 10.

When premixed gas M has reached the pipe leading-end opening 24a of the extension pipe 24, the first range S1 is relatively high in concentration thereof and the second range S2 is relatively low in concentration thereof.

That is, the premixed gas M which has flown out from a tube leading-end opening 23a burns earlier at the second range S2 which is inside the combustor basket 12 and lower in fuel concentration than at the first range S1.

Meanwhile, when the premixed gas M flows downstream, the cooling air a2 to a4 are included at the first range S1 during which the premixed gas M flows to the downstream region. The premixed gas M which would be otherwise relatively high in fuel concentration at the pipe leading-end opening 24a becomes low and similar in fuel concentration to the second range S2.

As described above, a range where the premixed gas M burns is sequentially shifted from inside to outside in the radial direction of the combustor basket 12. A flame front F is formed by the premixed gas M which is substantially equal in fuel concentration in the axial direction.

The thus formed flame front F is made uniform in flame temperature in the axial direction, producing NOx only slightly.

As described so far, according to the combustor 10, each of the main nozzles 14 supplies the premixed gas M by changing the fuel concentration around the nozzle center axis P3 thereof so that the flame front F is made uniform in temperature in the axial direction. It is, thus, possible to reduce a variance in fuel concentration of the premixed gas M in the axial direction.

Thereby, even if the cooling air a2 to a4 are included in the premixed gas M, the flame front F is to be formed by the premixed gas M which is uniform in fuel concentration across the axial direction. As a result, it is possible to suppress combustion of the flame front F at an uneven temperature in the axial direction and also suppress the occurrence of NOx.

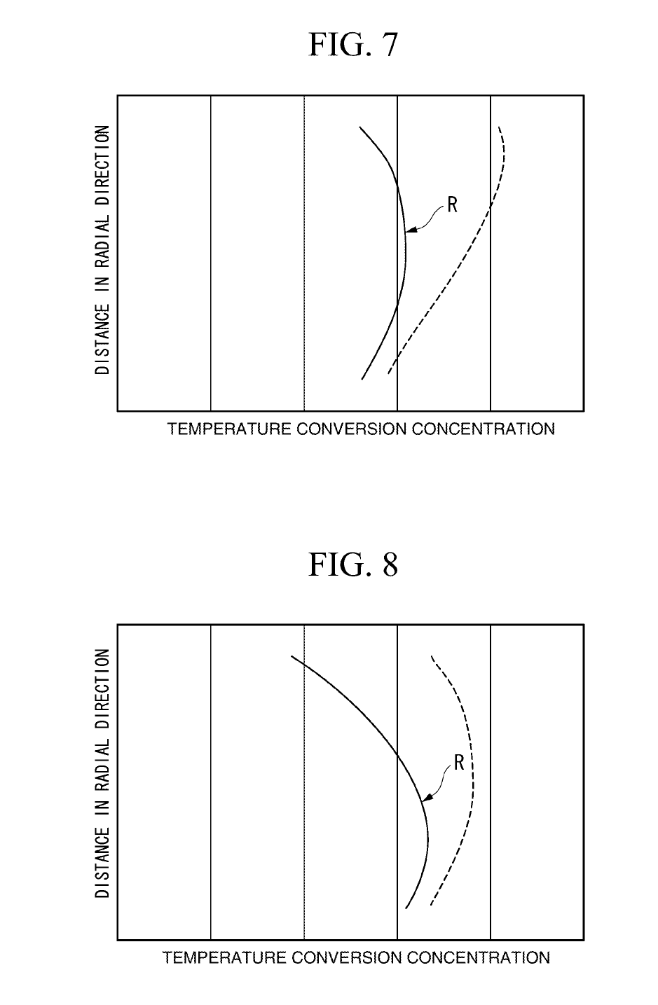

FIG. 7 is a graph which shows a temperature converted on the basis of fuel concentration of the premixed gas M in the radial direction at the pipe leading-end opening 24a and a flame temperature on the flame front F of the corresponding premixed gas M. In the graph, the solid line indicates a flame temperature on the flame front F of the premixed gas M, and the broken line indicates a value which is a temperature converted on the basis of the fuel concentration of the premixed gas M at the pipe leading-end opening 24a.

Further, FIG. 8 is a graph which shows a comparative example where the fuel ejection ports 22c are all made equal in opening area around each of the nozzle center axis P3 (the fuel ejection ports 22c of the fuel ejection part 22A are equal in port diameter to the fuel ejection ports 22c of the fuel ejection part 22B).

On the assumption that, as with the comparative example, the fuel ejection ports 22c are all made equal in opening area around each of the nozzle center axis P3 and the concentration distribution at the pipe leading-end opening 24a is made substantially uniform, the flame front F will have a temperature peak R (a maximum flame temperature) outside in the radial direction of the combustor basket 12, as shown by the solid line in FIG. 8, at which a flame temperature rises locally. On the other hand, the flame temperature decreases drastically along the outside in the radial direction from the temperature peak R.

This is due to the fact that the premixed gas M outside in the radial direction is likely to be decreased in fuel concentration by the cooling air a2 to a4.

Meanwhile, in the combustor 10 of the present invention, unlike the comparative example, as shown in FIG. 7, the concentration distribution is not uniform at the pipe leading-end opening 24a but the concentration outside in the radial direction is made relatively higher than inside in the radial direction. Further, in the combustor 10 of the present invention, unlike the comparative example, a flame temperature M of the premixed gas on the flame front F is substantially uniform. Still further, in the combustor 10 of the present invention, as shown by the solid line in FIG. 7, the temperature peak R is lower than the comparative example. Since a combustion temperature is uniform in general to reduce a local rise in flame temperature in the combustor 10, it is possible to sufficiently suppress the occurrence of NOx.

Further, at the pipe leading-end opening 24a of the main nozzle 14, the first range S1 which is outside in the radial direction of the combustor basket 12 is made relatively higher in fuel concentration than the second range S2 which is inside in the radial direction of the combustor basket 12. Therefore, the first range S1 which is relatively likely to decrease in fuel concentration and burns on the downstream side is increased in fuel concentration, while the second range S2 which is relatively less likely to decrease in fuel concentration and burns on the upstream side is decreased in fuel concentration.

Thereby, the premixed gas M which reaches the flame front F can be made uniform in fuel concentration in the axial direction using a relatively simple constitution.

Action procedures or various shapes and combinations of individual members shown in the above-described embodiments are just examples and may be modified in various ways on the basis of design requirements within a scope not departing from the gist of the present invention.

For example, in the above embodiments, the fuel ejection ports 22c are made different in opening area, by which an amount of the ejected fuel is made different to change the fuel concentration. However, it is acceptable that, instead of this, for example, individual fuel ejection ports 22c are changed in number and ejection pressure at the fuel ejection ports 22c to make the amount of the ejected fuel different, by which the fuel concentration is changed. Alternatively, they may be combined in an appropriate manner to change the fuel concentration.

Further, in the above embodiments, a description has been given of a constitution of the combustor 10 in which the main nozzles 14 are arrayed, with an interval kept, along the inner circumference surface of the combustor basket 12, a pilot flame is formed by using the pilot nozzle 13 disposed on the combustor center axis P2, by which the premixed gas from the main nozzles 14 is ignited to effect premixed combustion. The present invention will not be restricted to the above constitution. The present invention is also applicable, for example, to a combustor which is provided with a plurality of first nozzles arranged, with an interval kept, along an inner circumference surface of the combustor basket, and a second nozzle arranged on the combustor center axis and in which the first nozzle and the second nozzle are individually able to effect premixed combustion independently.

### INDUSTRIAL APPLICABILITY

The combustor of the present invention is able to suppress the occurrence of NOx.

The gas turbine of the present invention is able to constitute a gas turbine in which the occurrence of NOx is suppressed.

### DESCRIPTION OF REFERENCE NUMERALS

1: Gas turbine
10: Combustor
12: Combustor basket
14: Main nozzle (first nozzle)
15: Transition piece
15a: Leading-end opening (leading end in the axial direction)
15b: Base-end opening (base end)
22: Swirler
22A, 22B: Fuel ejection part
22c: Fuel ejection port
24a: Pipe leading-end opening (leading-end outlet)
P2: Combustor center axis
P3: Nozzle center axis (center axis of main nozzle)
S1: First range
S2: Second range
A: Compressed air (air)
F: Flame front
M: Premixed gas
f: Fuel

1. A combustor, comprising:
a combustor basket to which air is supplied from outside;
first nozzles which extend in an axial direction of the combustor basket and are installed in a plural number, with an interval kept, along an inner circumference of the combustor basket, thereby individually supplying premixed gas of the air with a fuel into the combustor basket; and
a transition piece, a base end of which is connected to the combustor basket, and which burns the premixed gas supplied from the first nozzles to form a flame front; wherein
each of the first nozzles supplies the premixed gas by changing the fuel concentration around the center axis of the first nozzle so that the flame front is made uniform in temperature in the axial direction.

2. The combustor according to claim 1, wherein
the first nozzle is configured so that a second range which is inside in the radial direction of the combustor basket is made relatively higher in fuel concentration of the premixed gas at a leading-end outlet of the first nozzle than a first range which is outside in the radial direction of the combustor basket.

3. The combustor according to claim 1, wherein
the first nozzle is configured so that the first range which is outside in the radial direction of the combustor basket is made relatively higher in fuel concentration of the premixed gas at the leading-end outlet of the first nozzle than the second range which is inside in the radial direction of the combustor basket.

4. The combustor according to claim 1, wherein
the first nozzle is provided with a nozzle main body which is installed on the center axis of the first nozzle,
swirlers which are installed in a plural number on an outer circumference of the nozzle main body to form a swirl flow of the premixed gas, and
a plurality of fuel ejection parts which is formed in each of the swirlers to eject the fuel, and
the plurality of fuel ejection parts ejects the fuel by changing an amount of the ejected fuel around the center axis of the first nozzle.

5. The combustor according to claim 4, wherein
the swirler is provided with the fuel ejection part at a plurality of sites in the radial direction of the nozzle main body, and
the plurality of fuel ejection parts ejects the fuel by changing the amount of the ejected fuel in the radial direction of the nozzle main body.

6. The combustor according to claim 4, wherein
each of the plurality of fuel ejection parts is provided with a fuel ejection port to change the amount of the ejected fuel by making an opening area of the fuel ejection port different.

7. The combustor according to claim 4, wherein
each of the plurality of fuel ejection parts is provided with a fuel ejection port to change the amount of the ejected fuel by making the number of the fuel ejection ports different.

8. The combustor according to claim 2, wherein
the first nozzle is provided with a nozzle main body installed on the center axis of the first nozzle,
swirlers installed in a plural number on an outer circumference of the nozzle main body to form a swirl flow of the premixed gas, and
a plurality of fuel ejection parts which is formed on each of the swirlers to eject the fuel, and
the plurality of fuel ejection parts ejects the fuel by changing the amount of the ejected fuel around the center axis of the first nozzle.

9. The combustor according to claim 8, wherein
the swirler is provided with the fuel ejection part at a plurality of sites in the radial direction of the nozzle main body, and
the plurality of fuel ejection parts ejects the fuel by changing the amount of the ejected fuel in the radial direction of the nozzle main body.

10. The combustor according to claim 8, wherein
each of the plurality of fuel ejection parts is provided with a fuel ejection port to change the amount of the ejected fuel by making an opening area of the fuel ejection port different.

11. The combustor according to claim 8, wherein
each of the plurality of fuel ejection parts is provided with a fuel ejection port to change the amount of the ejected fuel by making the number of the fuel ejection ports different.

12. The combustor according to claim 3, wherein
the first nozzle is provided with a nozzle main body installed on the center axis of the first nozzle,
swirlers which are installed in a plural number on an outer circumference of the nozzle main body to form a swirl flow of the premixed gas, and
a plurality of fuel ejection parts which are formed on each of the swirlers to eject the fuel, and
the plurality of fuel ejection parts ejects the fuel by changing the amount of the ejected fuel around the center axis of the first nozzle.

13. The combustor according to claim 12, wherein
the swirler is provided with the fuel ejection part at a plurality of sites in the radial direction of the nozzle main body, and
the plurality of fuel ejection parts ejects the fuel by changing the amount of the ejected fuel in the radial direction of the nozzle main body.

14. The combustor according to claim 12, wherein
each of the plurality of fuel ejection parts is provided with a fuel ejection port to change the amount of the ejected fuel by making an opening area of the fuel ejection port different.

15. The combustor according to claim 12, wherein
each of the plurality of fuel ejection parts is provided with a fuel ejection port to change the amount of the ejected fuel by making the number of the fuel ejection ports different.

16. A gas turbine, comprising:
a compressor;
the combustor according to claim 1; and
a turbine.

17. A gas turbine, comprising:
a compressor;
the combustor according to claim 2; and
a turbine.

18. A gas turbine, comprising:
a compressor;
the combustor according to claim 3; and
a turbine.
